(19) United States
(12) Patent Application Publication
(10) Pub. No.: US 2004/0255108 A1
(43) Pub. Date: Dec. 16, 2004

(54) Systems and methods for building advanced configuration and power interface namespaces

(76) Inventors: Martin O. Nicholes, Antelope, CA (US); Shiraz Ali Qureshi, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/461,615

(22) Filed: Jun. 13, 2003

(51) Int. Cl. G06F 15/177

(52) U.S. Cl. 713/1

(57) ABSTRACT

Methods for building advanced configuration and power interface (ACPI) namespaces are provided. One such method comprises: providing a first ACPI functional routine; and building an ACPI namespace that includes a device tree lacking at least the first ACPI functional routine. Systems also are provided.

### BACKGROUND

The advanced configuration and power interface (ACPI) describes industry standard interfaces for computer systems. In particular, ACPI involves the use of operating systems for directing configuration and power management of such computer systems.

Computer systems employing ACPI perform configuration and power management functions using ACPI code. Specifically, ACPI code is used to determine platform-specific information regarding the particular hardware and/or software, for example, of such a computer system. Once the configuration of the computer system has been determined, the ACPI code manages the power requirements of the various devices of the computer system.

ACPI code is stored in a portion of computer system memory known as ACPI namespace. An operating system of a computer system typically writes ACPI code into the ACPI namespace in a monolithic form. That is, ACPI code typically is written into memory as a single program that includes all of the ACPI functionality required for each device of the computer system. Typically, the ACPI code written into memory is in the form of a device tree, which identifies each of the devices of the computer system. The device tree also includes functional routines for each of the identified devices. Clearly, this can be problematic, as there tends to be a lack of standardization of computer system configurations. In particular, various combinations of operating systems, hardware devices, and software applications are used in computer systems. Thus, ACPI code tends to lack standardization and can be somewhat complex, as the imbedded functional routines of the device tree can add significant length to the ACPI code.

### SUMMARY

Systems and methods for building advanced configuration and power interface (ACPI) namespaces are provided. In this regard, an embodiment of a method for building an ACPI namespace of a computer system comprises: providing a first ACPI functional routine; and building an ACPI namespace that includes a device tree lacking at least the first ACPI functional routine.

Another embodiment of a method for building an ACPI namespace of a computer system comprises: providing a computer system having a first device, a second device and a memory, the memory including a first ACPI functional routine and a device tree, the device tree lacking at least the first ACPI functional routine; using the device tree and the first ACPI functional routine to obtain information corresponding to the first device; and using the device tree and the first ACPI functional routine to obtain information corresponding to the second device.

An embodiment of a system for building an ACPI comprises: an ACPI system operative to access information corresponding to a differentiated system description table (DSDT) and a secondary system description table (SSDT) and to build a library and a device tree, the library including at least a first ACPI functional routine, the device tree lacking at least the first ACPI functional routine.

An embodiment of a computer-readable medium having a computer program for building an ACPI namespace comprises: logic corresponding to a first ACPI functional routine; and logic configured to build an ACPI namespace that includes a device tree lacking at least the first ACPI functional routine.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

FIG. 1 is a schematic diagram depicting a computer or processor-based system that can be used to implement an embodiment of an advanced configuration and power interface (ACPI) system.

FIG. 2 is a schematic diagram depicting the memory of the system of FIG. 1.

FIG. 3 is a flowchart depicting functionality of the embodiment of FIG. 1.

FIG. 4 is a schematic diagram depicting the memory of FIGS. 1 and 2 after construction of the ACPI namespace.

FIG. 5 is a flowchart depicting functionality of another embodiment of an ACPI system.

FIG. 6 is a schematic diagram depicting an embodiment of an ACPI namespace and interaction of a device tree and library of that namespace.

FIG. 7 is schematic diagram depicting embodiments of two exemplary computer systems, each of which includes an embodiment of an ACPI system.

FIG. 8 is a flowchart depicting functionality of another embodiment of an ACPI system.

### DETAILED DESCRIPTION

Systems and methods, such as the several embodiments described herein, potentially alleviate at least some of the shortcomings of prior art advanced configuration and power interface (ACPI) code. This is accomplished by providing device trees that typically are customized for the devices with which the device trees are associated. Separate libraries of routines also are provided that include functionality associated with the device trees. Typically, a single library can support the functionality required of multiple device trees and, thus, can be device independent. For instance, a single library can be constructed for use with multiple device configurations and associated device trees, potentially resulting in economy of ACPI code design. Additionally or alternatively, a functional routine of a library can be used by multiple devices of a computer system so that multiple instances of the functional routine need not be included in the ACPI code as is typically done in the prior art.

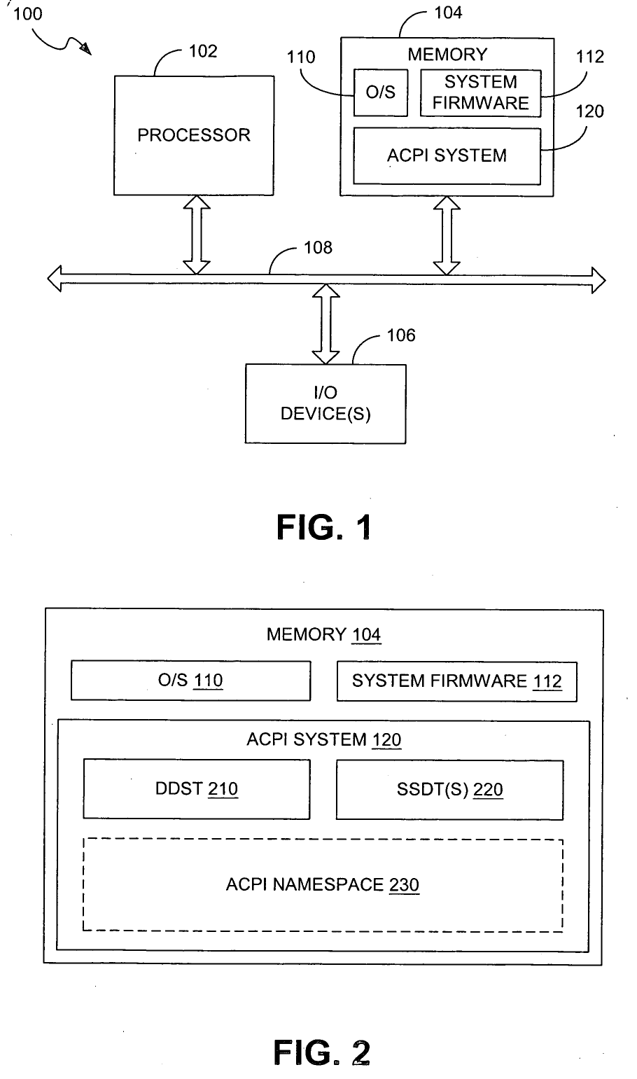

The aforementioned functionality may generally be attributed to an ACPI system that is implemented by a computer or processor-based device. An embodiment of an ACPI system is depicted schematically in FIG. 1, which will be described in detail later. Embodiments of ACPI systems can be implemented in software, firmware, hardware, or combinations thereof. When implemented in hardware, embodiments of ACPI systems can be implemented with any or a combination of various technologies. By way of example, the following technologies, which are each well known in the art, can be used: a discrete logic circuit(s) having logic gates for implementing logic functions upon data signals, an application specific integrated circuit(s) (ASIC) having appropriate combinational logic gates, a programmable gate array(s) (PGA), and a field programmable gate array(s) (FPGA).

When implemented in software, it should be noted that embodiments of an ACPI system can be stored on a computer-readable medium for use by or in connection with a computer-related system or method. In the context of this document, a computer-readable medium is an electronic, magnetic, optical, or other physical device or means that can contain or store a computer program for use by or in connection with a computer-related system or method. Such an ACPI system can be embodied in a computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can store, communicate, propagate or transport a program for use by or in connection with an instruction execution system, apparatus, or device. Thus, a computer-readable medium can be, for example but not limited to, an electronic, magnetic, optical, electromagnetic, infrared, or semiconductor system, apparatus, device, or propagation medium. More specific examples (a nonexhaustive list) of a computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program could be electronically captured, via optical scanning of the paper or other medium, then compiled, interpreted or otherwise processed in a suitable manner, if necessary, and then stored in a computer memory.

When implemented in software, an ACPI system can include a program that is executable by a digital computer, an example of which is depicted schematically in FIG. 1. In FIG. 1, computer 100 includes a processor 102, memory 104, and one or more input and/or output (I/O) devices 106 (or peripherals) that are communicatively coupled via a local interface 108.

Processor 102 can be a hardware device configured to execute software that can be stored in memory 104. Memory 104 can include any combination of volatile memory elements and/or nonvolatile memory elements. Note that memory 104 can have a distributed architecture, where various components are situated remote from one another, but can be accessed by processor 102.

The I/O device(s) 106 can include input devices such as a keypad, output devices such as a display device and/or devices that are configured to communicate both inputs and outputs such as a communication interface.

The memory 104 can include one or more separate programs, each of which comprises an ordered listing of executable instructions for implementing logical functions. Specifically, the memory 104 includes an operating system (O/S) 110 and system firmware 112. The system firmware initializes and tests hardware at startup, starts the O/S and supports the transfer of data among the hardware devices. Typically, the system firmware is stored in ROM so that the system firmware 112 can be executed when the computer system is activated.

Also shown in memory 104 of FIG. 1 is an embodiment of an ACPI system 120. As shown in greater detail in FIG. 2, ACPI system 120 includes a differentiated system description table (DDST) 210 and may include one or more secondary system description tables (SSDT). The DDST and the SSDT(s) provide the instructions that enable the O/S 110 to build the ACPI namespace 230, as well as the underlying functionality required for ACPI operation. Typically, the DDST 210 and accompanying SSDT(s) 220 are loaded into main memory by the system firmwarel 12. The O/S 110 then analyzes the DDST 210 and any accompanying SSDT(s) 220 written into main memory and builds the ACPI namespace 230 in accordance with the instructions.

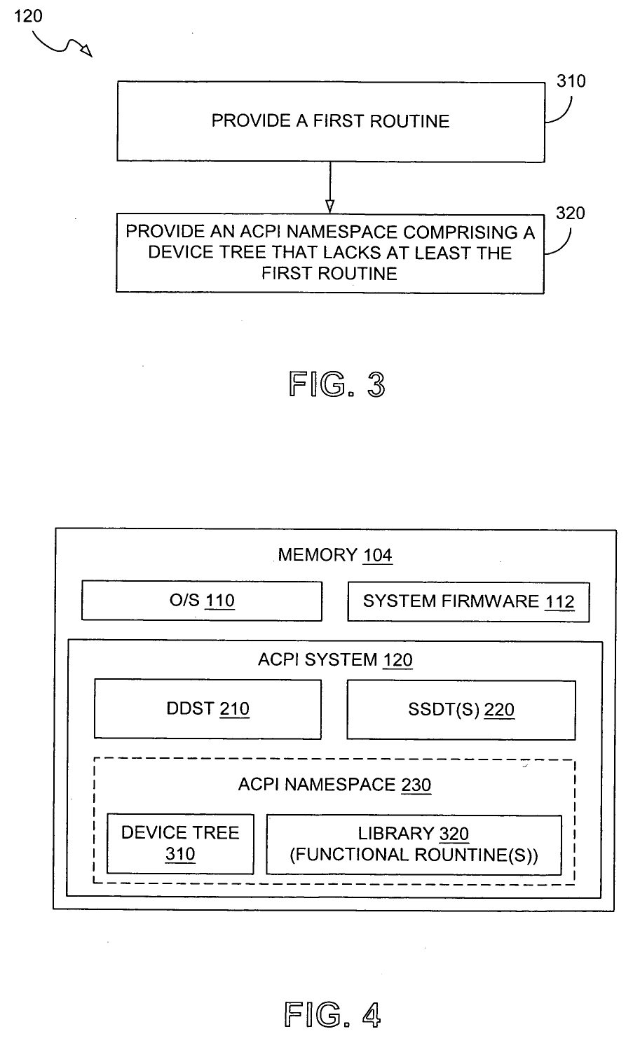

Reference will now be made to the flowchart of FIG. 3, which depicts the functionality of the ACPI system 120 of FIGS. 1 and 2. In this regard, each block of the flowchart represents a module segment or portion of code that comprises one or more executable instructions for implementing the specified logical function(s). It should also be noted that, in some alternative implementations, the functions noted in various blocks of the flowcharts of this disclosure may occur out of the order in which they are depicted. For example, two blocks shown in succession may, in fact, be executed substantially concurrently. In other embodiments, the blocks may sometimes be executed in the reverse order depending upon the functionality involved.

As shown in FIG. 3, the functionality (or method) may be construed as beginning at block 310, where a first routine is provided. Specifically, the first routine is an ACPI functional routine that includes information for facilitating ACPI functionality. In block 320, an ACPI namespace is provided that comprises a device tree which lacks at least the first routine. In particular, the device tree includes information that identifies each of the devices of the computer system and enables the first routine to be accessed. Thus, the first routine provides the ACPI functionality required by the devices identified by device tree. Referring now to FIG. 4, building of an ACPI namespace 230 will be described in greater detail.

As shown in the schematic diagram of FIG. 4, ACPI system 120 includes a device tree 310 and a library 320. The library 320 includes one or more routines, each of which provides functionality, e.g., ACPI functionality, that can be accessed by the device tree 310. Specifically, the O/S 110 builds that portion of memory 104 designated as the ACPI namespace 230 by interacting with the device tree 310. As will be described in greater detail later, the device tree 310 directs the O/S 110 to access various routines of the library 320 so that device-specific information can be provided to an appropriate location of the ACPI namespace 230.

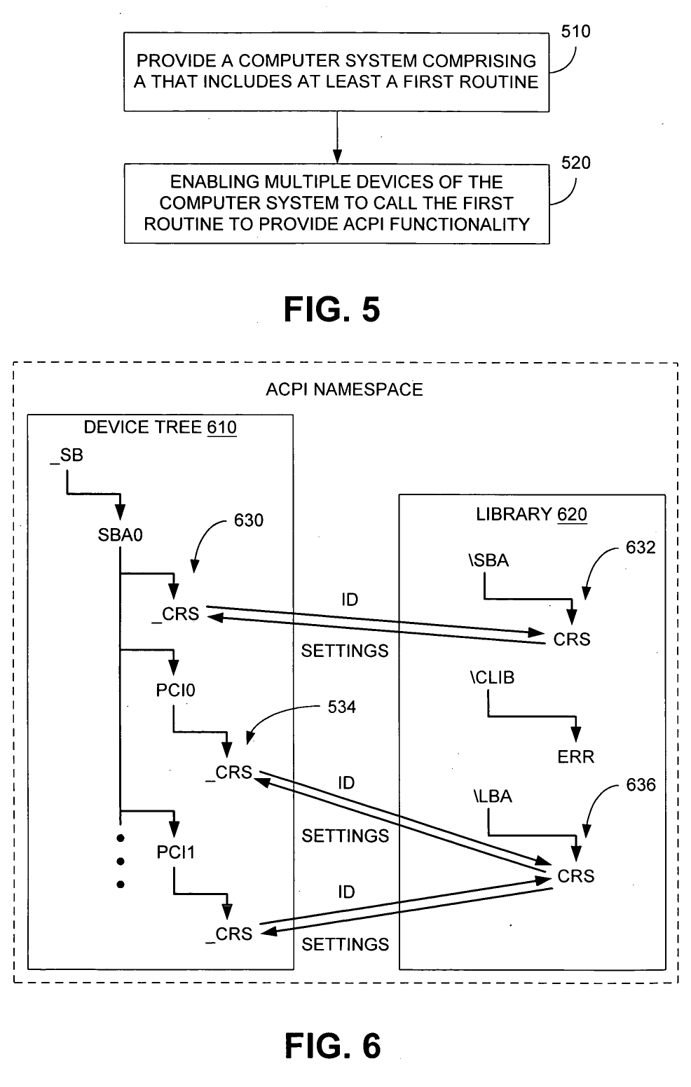

Functionality of another embodiment of an ACPI system is depicted in the attachment of FIG. 5. As shown in FIG. 5, the functionality (or method) associated with ACPI system may be construed as beginning at block 510, where a computer system is provided that includes an ACPI namespace comprising at least a first routine. In block 520, multiple devices of the computer system are enabled to call the first routine in order to provide ACPI functionality.

Interaction of an embodiment of an ACPI system that functions as described above with respect to FIG. 5 is depicted schematically in FIG. 6. As shown in FIG. 6, the ACPI namespace 605 of such an embodiment includes a device tree 610 and a library 620. Device tree 610 is a relatively simplistic code structure that describes the configuration of the computer system (not shown) with which the device tree is associated. In the portion of the device tree depicted, a system bus _SB is provided. The system bus _SB includes a system root bridge SBA0, as well as links to related devices and/or objects. Specifically, SBA0 includes a _CRS object, and system PCI host bridges, PCI0 and PCI1. Note, each of the system PCI host bridges includes a link to a corresponding _CRS object.

Library 620 is depicted as including multiple library routines, each of which includes functionality for a corresponding object of the device tree 610. Specifically, library 620 includes routines that can return information about objects in the device tree 610. In operation, an operating system builds ACPI namespace (not shown) which contains the device tree 610 and the library 620.

For example, the \SBA.CRS routine 632 returns information about the current resources settings of the particular calling object in the device tree. The calling object passes an identification number to the library routine to specify the particular object. In the case that \_SB.SBA0._CRS 630 is called in the device tree, that code calls the library routine \SBA.CRS 632, passing the caller's identification number. The library routine determines the correct values and then returns the values. Thus, the library routine CRS 632 provides functionality that enables settings of the system root bridge SBA0 to be determined and provided for use in the ACPI namespace. Note, the calls to library routines from the device tree typically are hard-coded direct calls. In some embodiments, indirect calls could be used. For example, a look-up table could be used.

Similarly, when the operating system identifies the entry point associated with _CRS 634 of system PCI host bridge PCI0, the associated library routine CRS 636 is called. This includes passing a unique device ID to CRS 636 so that CRS 636 can return the corresponding device settings for PCI0. Note that the crs function associated with PCI1 also uses library routine CRS 636. Thus, multiple devices of the device tree 610 utilize the same portion of ACPI code of the library 620 for providing the required functionality. Because of this, multiple instances of code may not need to be provided within a library for use with similar devices.

Another example is the \CLIB.ERR library routine that can be called from locations in the code where an error needs to be handled. This allows centralized error-handling in the ACPI library and device tree. In this way, an error code can be passed to the central routing for logging.

Note, various functional objects other than _CRS can be used. By way of example, other objects such as _STA, _HID and _PRT, can be used. Specifically, _STA is an object that returns the status of a device, e.g., whether the device is enabled, disabled or removed. _HID is an object that provides the Plug-and-Play hardware ID of a device. _PRT is an object that describes the PCI interrupt routing in use under a PCI bridge device.

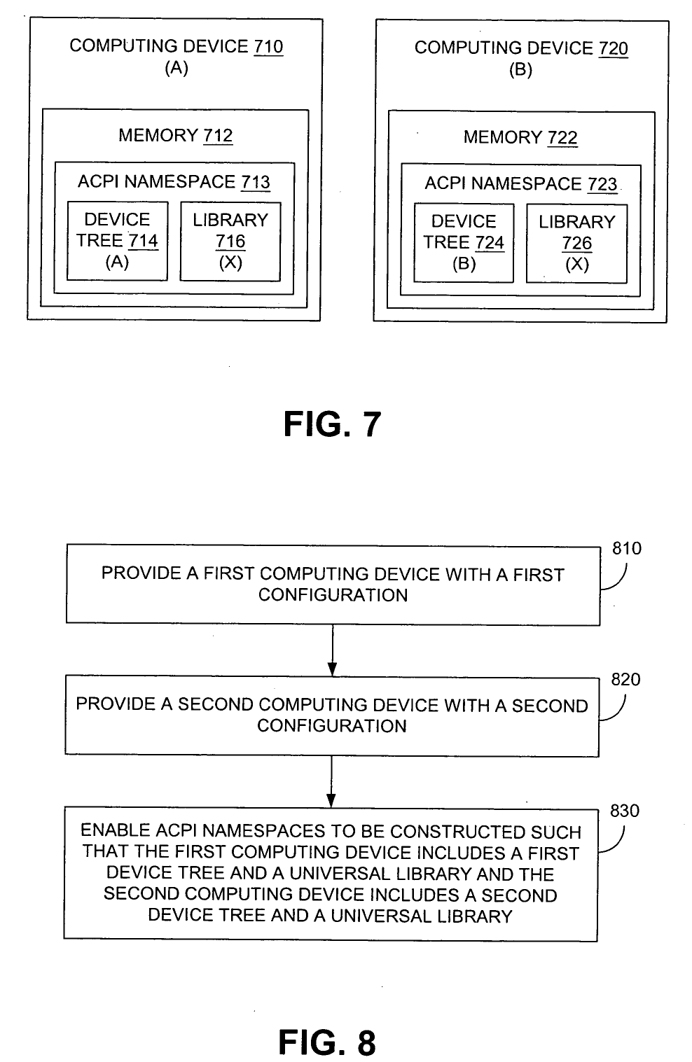

Another aspect of some embodiments of ACPI systems will now be described with reference to FIGS. 7 and 8. As shown in FIG. 7, two computing devices are provided. Specifically, a first computing device 710, which exhibits configuration A, and a second computing device 720, which exhibits configuration B, are depicted. Each of the computing devices includes a memory, i.e., memory 712 and 722, respectively. Correspondingly, each memory includes an ACPI namespace that incorporates a device tree which is constructed based upon the configuration of the computing device with which it is associated. Specifically, ACPI namespace 713 of computing device 710 includes a device tree 714 that is particularly constructed for operating with configuration A devices. ACPI namespace 723 includes a device tree 724 that is constructed to be operative with configuration B devices.

In contrast to the configuration-specific device trees of computing devices 710 and 720, the libraries of these devices are identical. Specifically, library 716 of computing device 710 is identical to library 726 of computing device 720. Thus, a configuration-independent library can be used with multiple configurations of computing devices. Typically, this requires constructing a library with multiple functional routines, including some routines that may not be used by particular computing device configurations. By way of example, if configuration A devices require the use of routines A and B, and configuration B devices require the use of routines B and C, a configuration-independent library should include at least routines A, B and C. This functionality is generally depicted in the flowchart of FIG. 8.

As shown in FIG. 8, the functionality (or method) may be construed as beginning at block 810, where a first computing device with a first configuration is provided. In block 820, a second computing device with a second configuration is provided. In block 830, ACPI namespaces are enabled to be constructed on each of the computing devices. Specifically, the ACPI namespace of the first computing device includes a first device tree and a universal library of ACPI functional routines, and the second computing device includes a second device tree and a universal library of ACPI functional routines. Thus, each of the computing devices includes a configuration-specific device tree and a copy of a library that is compatible with multiple computing device configurations.

It should be emphasized that many variations and modifications may be made to the above-described embodiments. All such modifications and variations are intended to be included herein within the scope of this disclosure and protected by the following claims.

1. A method for building an advanced configuration and power interface (ACPI) namespace of a computer system, said method comprising:
providing a first ACPI functional routine; and
building an ACPI namespace that includes a device tree lacking at least the first ACPI functional routine.

2. The method of claim 1, further comprising:
evaluating the device tree with an operating system to identify information corresponding to a first device of the computer system; and
initiating a call to the first ACPI functional routine in response to identifying information corresponding to the first device.

3. The method of claim 2, further comprising:
providing a library which includes at least the first ACPI functional routine; and
further comprising:
further evaluating the device tree;
identifying second information corresponding to a second device of the computer system; and
initiating a call to the library in response to identifying the second information.

4. The method of claim 3, wherein initiating the call to the library comprises initiating the call to the first ACPI functional routine.

5. A method for building an advanced configuration and power interface (ACPI) namespace of a computer system, said method comprising:
providing a computer system having a first device, a second device and a memory, the memory including a first ACPI functional routine and a device tree, the device tree lacking at least the first ACPI functional routine;
using the device tree and the first ACPI functional routine to obtain information corresponding to the first device; and
using the device tree and the first ACPI functional routine to obtain information corresponding to the second device.

6. The method of claim 5, wherein using the device tree and the first functional routine to obtain information corresponding to the first device comprises:
evaluating the device tree with an operating system; and
initiating a call to the first ACPI functional routine.

7. The method of claim 6, wherein the call to the first ACPI functional routine is a direct call.

8. A system for building an advanced configuration power interface (ACPI) namespace, said system comprising:
an ACPI system operative to access information corresponding to a differentiated system description table (DSDT) and a secondary system description table (SSDT) and to build a library and a device tree, the library including at least a first ACPI functional routine, the device tree lacking at least the first ACPI functional routine.

9. The system of claim 8, further comprising:
a memory storage device, the ACPI system being stored on the memory storage device.

10. The system of claim 9, wherein the memory storage device comprises a basic system firmware and an operating system (O/S); and
wherein the system firmware enables the DDST and SSDT to be written to the memory storage device and the O/S analyzes the DSDT and the SSDT to build the library and the device tree.

11. The system of claim 8, further comprising:
a first computer system of a first device configuration, the first computer system comprising the memory storage device.

12. The system of claim 11, further comprising:
a second computer system of a second device configuration, the second device configuration being different than the first device configuration, the second computer system comprising a second ACPI system which includes a second library identical to the library of the first computer system.

13. The system of claim 12, wherein the second ACPI system includes a second device tree configured differently than the device tree of the first computing device.

14. The system of claim 11, wherein the first computer system comprises a first device, and the ACPI system is operative to access the first ACPI functional routine to obtain information corresponding to the first device.

15. The system of claim 14, wherein the first computer system comprises a second device, and the ACPI system is operative to access the first ACPI functional routine to obtain information corresponding to the second device.

16. The system of claim 14, wherein the first computer system comprises means for storing the ACPI system.

17. A computer-readable medium having a computer program for building an advanced configuration and power interface (ACPI) namespace, said computer program comprising:
logic corresponding to a first ACPI functional routine; and
logic configured to build an ACPI namespace that includes a device tree lacking at least the first ACPI functional routine.

18. The computer-readable medium of claim 17, further comprising:
logic configured to evaluate the device tree with an operating system to identify information corresponding to a first device of the computer system; and
logic configured to initiate a call to the logic corresponding to the first ACPI functional routine in response to identifying information corresponding to the first device.

19. The computer-readable medium of claim 18, further comprising:
logic configured to identify second information corresponding to a second device of the computer system; and
logic configured to initiate a call in response to identifying the second information.

20. The computer-readable medium of claim 19, wherein the logic configured to initiate the call initiates the call to the logic corresponding to the first ACPI functional routine.
